(19) United States
(12) Patent Application Publication
(10) Pub. No.: US 2026/0112970 A1
(43) Pub. Date: Apr. 23, 2026

(54) METHOD TO IMPLEMENT A PROPORTIONAL CONTROLLER IN TIME-BASED DC-DC CONVERTERS

(71) Applicants: STMicroelectronics International N.V., Geneva (CH); Politecnico di Milano, Milano (IT)

(72) Inventors: Alessandro BERTOLINI, Vermiglio (IT); Alessandro GASPARINI, Cusano Milanino (IT); Paolo MELILLO, Caltanissetta (IT); Massimo GHIONI, Monza (IT); Salvatore LEVANTINO, Milano (IT)

(73) Assignees: STMicroelectronics International N.V., Geneva (CH); Politecnico di Milano, Milano (IT)

(21) Appl. No.: 18/920,428

(22) Filed: Oct. 18, 2024

(51) Int. Cl. H02M 3/158; H02M 1/00

(52) U.S. Cl. CPC H02M 3/158; H02M 1/0025

(57) ABSTRACT

Disclosed herein is a DC-DC converter with an improved time-domain control system. The converter includes a DC-DC converter circuit, a feedback network, a high-pass filter, and a time-domain proportional-integral compensator circuit. The compensator circuit receives a feedback voltage and a filtered voltage, generates oscillating signals based on these voltages, and produces a drive signal by comparing the oscillating signals. Driver circuits control the converter circuit based on this drive signal. The time-domain compensator circuit includes transconductors, current-controlled oscillators, and a phase detector, implementing proportional-integral control in the time domain without delay lines. This approach offers improved response time and efficiency compared to traditional voltage-based or digital control methods.

### TECHNICAL FIELD

This disclosure relates to the field of power electronics, specifically to DC-DC converters. More particularly, this disclosure relates to time-based control systems for DC-DC converters that accomplish such time-based control without the use of delay lines.

### BACKGROUND

DC-DC converters are electronic circuits that convert a source of direct current (DC) from one voltage level to another. These converters utilize precise control to maintain a stable output voltage despite variations in input voltage or load conditions. This control is achieved through feedback systems known as controllers.

There are three main types of controllers used in DC-DC converters, namely voltage-based controllers, digital controller, and time-based controllers.

Voltage-based controllers use analog circuitry to process voltage signals. They compare the output voltage to a reference voltage and generate an error signal, which is then used to adjust the duty cycle of the power stage of the DC-DC converter to increase or decrease the output voltage to maintain it at the desired level.

Digital controllers use digital signal processing techniques to perform the control function. They convert analog signals (e.g., the output voltage) to digital signals, process them using algorithms implemented in digital hardware, and then convert the result back to an analog signal to control the duty cycle of the power stage of the DC-DC converter to increase or decrease the output voltage to maintain it at the desired level.

Unlike traditional voltage-based or digital controllers, time-based controllers represent and process signals as time differences rather than voltage levels or digital values. Indeed, the fundamental principle of time-based control is to represent the error between the desired and actual output voltage as a time difference.

In a time-based controller, the time difference representing the error signal is used to adjust the switching behavior of the power stage of the DC-DC converter. By modifying the timing and duration of the switching events of the power stage, the controller can regulate the output voltage, much like adjusting the duty cycle in traditional control methods.

In a time-based controller, two components work together to implement the control strategy: a Voltage-Controlled Oscillator (VCO) and a Voltage-Controlled Delay Line (VCDL). These components are arranged to perform a proportional-integral (PI) control function in the time domain. The VCO contributes to integral control by accumulating the effect of past errors over time, while the VCDL provides proportional control by quickly responding to changes in the error signal.

More specifically, the VCO generates a clock signal with a frequency proportional to the input voltage, which is derived from the error between the desired and actual output voltages. This output frequency determines the base switching frequency of the converter, allowing dynamic adjustment of the conversion process in response to changing conditions.

Meanwhile, the VCDL introduces a variable time delay to a signal, with the delay controlled by an applied voltage. In the time-based controller, the VCDL fine-tunes the timing of the switching events relative to the base frequency set by the VCO. This precise timing control is crucial for implementing the integral portion of the PI control, optimizing efficiency, and maintaining a stable output voltage.

The time-based approach offers potential advantages in terms of area efficiency and performance compared to traditional voltage-based or digital controllers. However, the use of the VCDLs in these systems presents several challenges. For example, VCDLs add delays to the control loop, which can slow the system's response to changes and potentially lead to instability. In addition, VCDLs require significant silicon area, limiting miniaturization efforts. Furthermore, these components are often power-hungry, reducing the overall efficiency of the DC-DC converter system. Moreover, VCDLs typically exhibit non-linear behavior, making them difficult to manage and potentially causing inconsistent performance across different operating conditions.

Due to these challenges, there is a pressing need for developments to address these issues while maintaining or improving the performance benefits of time-based control systems in DC-DC converters.

### SUMMARY

A DC-DC converter includes a DC-DC converter circuit that generates an output voltage from an input voltage, and a feedback network that generates a feedback voltage from the output voltage. A control circuit has a high-pass filter that generates a filtered voltage from the feedback voltage. A time-domain proportional-integral compensator circuit receives the feedback voltage and filtered voltage, generates first and second oscillating signals based on these voltages, and generates a drive signal by comparing the oscillating signals. A driver circuit controls the DC-DC converter circuit operation based on the drive signal.

The time-domain proportional-integral compensator circuit may have first and second transconductors that convert the feedback and filtered voltages to currents respectively. A feedback current-controlled oscillator (FCCO) may generate the first oscillating signal from the first current. A reference current-controlled oscillator (RCCO) may generate the second oscillating signal from the second current. A phase detector may compare phases of the oscillating signals to generate the drive signal.

The first transconductor may have a non-inverting input for the feedback voltage and an inverting input connected to a reference voltage. The second transconductor may have a non-inverting input for the filtered voltage and an inverting input connected to a reference voltage. The phase detector may generate the drive signal to control duty cycles of switching elements based on the phase difference between oscillating signals.

The feedback network may include a voltage divider between an output node and ground. The high-pass filter may have a capacitor between a feedback node and filter node, and a resistor between the filter node and a reference voltage. An inverter may connect the compensator circuit to a driver circuit. The compensator circuit may implement proportional-integral control in the time domain without delay lines.

The converter may include additional circuits: A current steering circuit may direct a reference current between first and second nodes based on the drive signal. An error integrator may accumulate charge at the second node, representing integrated error from the drive signal duty cycle. A low-pass filter may filter voltage at the first node. A phase compensation circuit may process the filtered voltage to provide phase-advanced signals for modulating the oscillating signals.

The current steering circuit may use a current mirror for the reference current, with switches controlled by the drive signal and its inverse to direct current to the nodes. The error integrator may use a capacitor to accumulate charge and a biased transistor. The low-pass filter may use an RC circuit. The phase compensation may use a buffer, capacitor, resistor, and transconductors to convert voltage differences to currents for the oscillators.

The method of operation involves generating the output and feedback voltages, high-pass filtering the feedback voltage, converting voltages to currents, generating oscillating signals with current-controlled oscillators, comparing signal phases for the drive signal, and controlling the converter based on this signal.

The method may include directing reference current between nodes based on the drive signal, accumulating charge for error integration, low-pass filtering node voltage, processing this for phase-advanced signals, and modulating oscillating signals with these. Current steering may use a current mirror and complementary switches. Phase advance processing may involve buffering, RC networks, and voltage-to-current conversion for oscillator modulation.

### BRIEF DESCRIPTION OF THE DRAWINGS

FIG. 1 is a schematic block diagram of a first embodiment of a DC-DC converter described herein utilizing time-based control.

FIG. 2 is a schematic block diagram of a second embodiment of a DC-DC converter described herein utilizing time-based control.

### DETAILED DESCRIPTION

The following disclosure enables a person skilled in the art to make and use the subject matter described herein. The general principles outlined in this disclosure can be applied to embodiments and applications other than those detailed above without departing from the spirit and scope of this disclosure. It is not intended to limit this disclosure to the embodiments shown, but to accord it the widest scope consistent with the principles and features disclosed or suggested herein.

Note that in the following description, any resistor or resistance mentioned is a discrete device, unless stated otherwise, and is not simply an electrical lead between two points. Therefore, any resistor or resistance connected between two points has a higher resistance than a lead between those two points, and such resistor or resistance cannot be interpreted as a lead. Similarly, any capacitor or capacitance mentioned is a discrete device, unless stated otherwise, and is not a parasitic element, unless stated otherwise. Additionally, any inductor or inductance mentioned is a discrete device, unless stated otherwise, and is not a parasitic element, unless stated otherwise.

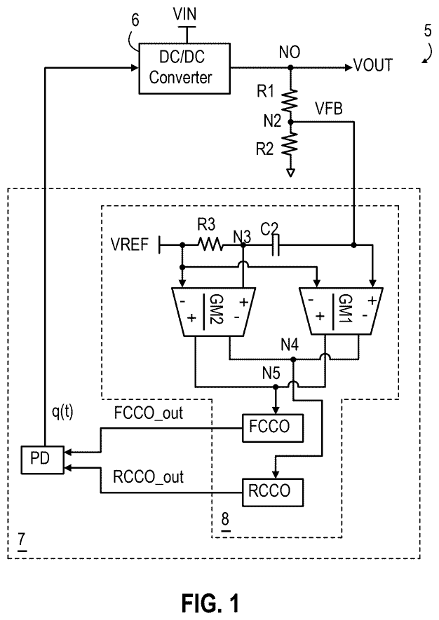

Disclosed herein is a DC-DC converter 5. A general block diagram of the DC-DC converter 5 is shown in FIG. 1. Referring to FIG. 1, the DC-DC converter 5 includes a converter circuit 6 and a control circuit 7. The converter circuit 6 is connected to convert the input voltage VIN to an output voltage VOUT generated at an output node NOUT of the DC-DC converter. Resistors R1 and R2 are connected in series between the output node NOUT and ground, with node N2 being a tap between resistors R1 and R2. A feedback voltage VFB is formed at node N2.

The control circuit 7 includes a time-domain proportional-integral compensator circuit 8. The time-domain proportional-integral compensator circuit 8 includes a capacitor C2 connected between nodes N2 and N3, and a resistor R3 connected between node N3 and a reference voltage VREF. The time-domain proportional-integral compensator circuit 8 further includes a first transconductor GM1 and a second transconductor GM2. The first transconductor GM1 has its non-inverting input connected to node N2 and its inverting input connected to the reference voltage VREF. The second transconductor GM2 has its non-inverting input connected to node N3 and its inverting input connected to the reference voltage VREF. The first and second transconductors GM1 and GM2 have their inverting outputs connected to node N4, and have their non-inverting outputs connected to node N5. Within the time-domain proportional-integral compensator circuit 8, a feedback current controlled oscillator (FCCO) has its input connected to node N5 and generates the feedback oscillator output FCCO_out at is output, and a reference current controlled oscillator (RCCO) has its input connected to node N4 and generates a reference oscillator output RCCO_out at its output.

The control circuit 7 includes a phase detector circuit PD that receives the feedback oscillator output FCCO_out and the reference oscillator output RCCO_out, and generates the drive signal q(t) based thereupon.

In operation, the DC-DC converter 5 regulates the output voltage at node NO based on the feedback voltage VFB at node N2. The control circuit 7 processes this feedback signal through two paths. The capacitor C2 and resistor R3 form a high-pass filter, which emphasizes the high-frequency components of the feedback signal at node N3, effectively creating a path that responds to rapid changes in the feedback voltage.

Transconductors GM1 and GM2 convert the voltages at nodes N2 and N3 into currents, which are then injected into the feedback current controlled oscillator (FCCO) and reference current controlled oscillator (RCCO) at nodes N5 and N4, respectively. The CCOs inherently perform an integration function in the phase domain, as the phase of their output signals accumulates over time based on the input current.

The FCCO and RCCO generate oscillating signals FCCO_out and RCCO_out, whose frequencies are proportional to their received input currents. These signals are fed into the phase detector circuit PD, which compares their phases to generate the drive signal q(t).

The time-based control is achieved through this phase comparison. The phase difference between FCCO_out and RCCO_out represents the error in the output voltage, encoded in the time domain. The PD circuit translates this time-domain error into the drive signal q(t), which controls the duty cycle of the switching transistors.

By utilizing the inherent integration of the CCOs and the high-pass characteristic of the RC network, the control circuit 7 achieves a proportional-integral control function in the time domain without separate delay lines, resulting in improved response time and efficiency. Indeed, the DC-DC converter embodiment illustrated in FIG. 1 offers several significant advantages over traditional control methods. By implementing a time-domain proportional-integral compensator circuit, this design eliminates the need for current-controlled delay lines (CCDLs) typically used in time-based controllers. This removal of CCDLs addresses key issues such as latency, area consumption, and power inefficiency that are often associated with conventional time-based control systems. The use of current-controlled oscillators (CCOs) to perform integration in the phase domain, combined with the direct injection of the derivative of the input signal, allows for a more efficient and responsive control loop. This approach achieves a proportional-integral transfer function without the complexities and non-linearities introduced by delay lines. As a result, the converter can potentially offer better efficiency due to reduced power consumption in the control circuitry, and a smaller silicon footprint. Additionally, the time-based nature of the control may provide enhanced noise immunity compared to voltage-based systems, as time measurements are generally less susceptible to voltage noise and interference.

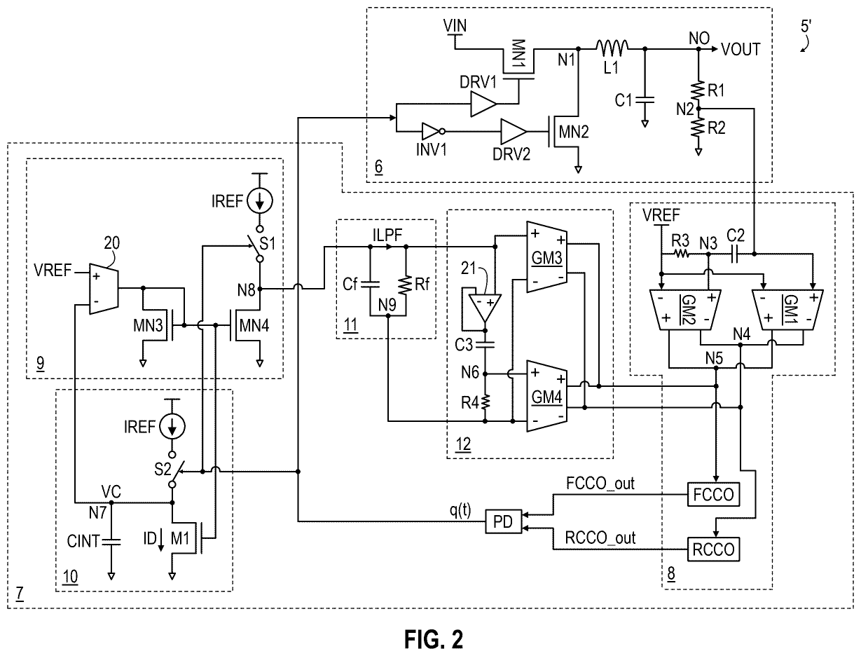

Now described with reference to FIG. 2 is a further embodiment of the DC-DC converter 5′. The DC-DC converter 5 includes a converter circuit 6 and a control circuit 7. The converter circuit 6 includes an n-channel power transistor MN1 having its drain connected to an input voltage node to receive an input voltage VIN, its source connected to node N1, and its gate receiving a first driving signal from a first driver DRV1, and an n-channel power transistor MN2 having its drain connected to node N1, its source connected to a ground node, and its gate receiving a second driving signal from a second driver DRV2. An inductor L1 is connected between node N1 and an output node NO, and an output capacitor C1 is connected between output node NO and the ground node. A first feedback resistor R1 is connected between nodes NO and N2, and a second feedback resistor R2 is connected between node N2 and the ground node, with a feedback voltage VFB being formed at node N2. The first driver DRV1 generates the first driving signal based upon output from inverter INV1, which inverts driving signal q(t) generated by the control circuit 7, and the second driver DRV2 generates the second driving signal based on the driving signal D.

Changes are present in the control circuit 7 as compared to the embodiment of FIG. 1. While the arrangement of the time-domain proportional-integral compensator circuit 8 and phase detector circuit PD circuit also remain the same, the control circuit further includes current mirroring and steering circuit 9, error integrator circuit 10, low-pass filtering circuit 11, and phase compensation circuit 12.

Current mirroring and steering circuit 9 includes an amplifier 20 having its non-inverting input connected to receive the reference voltage VREF and its inverting input connected to node N7, at which voltage VC is formed. N-channel transistor MN3 has its drain connected to the output of the amplifier 20, its source connected to ground, and its gate connected to its drain as well as to the gate of n-channel transistor MN4. N-channel transistor MN4 has its drain connected to switch S1, which selectively provides reference current IREF to node N8. The drain of n-channel transistor MN4 is connected to node N8, the source of MN4 is connected to ground, and the gate of MN4 is connected to the gate and drain of n-channel transistor MN3. Switch S1 is controlled by drive signal q(t).

Turning now to error integrator circuit 10, it includes an integration capacitor CINT connected between node N7 and ground, and n-channel transistor M1 having its drain connected to node N7, its source connected to ground, and its gate connected to the gates of n-cannel transistors MN3 and MN4. A switch S2 selectively provides reference current to node N7. Switch S2 is controlled by drive signal q(t).

Low-pass filtering circuit 11 includes filter capacitor Cf connected between node N8 and node N9 and filter resistor Rf connected between nodes N8 and N9.

Phase compensation circuit 12 includes a buffer 21 connected between nodes N8 and capacitor C3. Capacitor C3 is connected between the output of buffer 21 and node N6. Resistor R4 is connected between nodes N6 and N9. Circuit 12 includes transconductors GM3 and GM4. Transconductor GM3 has its non-inverting input connected to node N8, its inverting input connected to node N9, its non-inverting output connected to node N5, and its inverting output connected to node N4. Transconductor GM4 has its non-inverting input connected to node N4, its inverting input connected to node N9, its non-inverting output connected to node N5, and its inverting output connected to node N4.

The control circuit 7 includes a time-domain proportional-integral compensator circuit 8. The time-domain proportional-integral compensator circuit 8 includes a capacitor C2 connected between nodes N2 and N3, and a resistor R3 connected between node N3 and a reference voltage VREF. The time-domain proportional-integral compensator circuit 8 further includes a first transconductor GM1 and a second transconductor GM2. The first transconductor GM1 has its non-inverting input connected to node N2 and its inverting input connected to the reference voltage VREF. The second transconductor GM2 has its non-inverting input connected to node N3 and its inverting input connected to the reference voltage VREF. The first and second transconductors GM1 and GM2 have their inverting outputs connected to node N4, and have their non-inverting outputs connected to node N5. Within the time-domain proportional-integral compensator circuit 8, a feedback current controlled oscillator (FCCO) has its input connected to node N5 and generates the feedback oscillator output FCCO_out at is output, and a reference current controlled oscillator (RCCO) has its input connected to node N4 and generates a reference oscillator output RCCO_out at its output.

The control circuit 7 includes a phase detector circuit PD receives the feedback oscillator output FCCO_out and the reference oscillator output RCCO_out, and generates the drive signal q(t) based thereupon.

In operation, the DC-DC converter 5′ enhances the time-based control strategy. The control circuit 7 aims to maintain a constant output voltage by adjusting the switching of the converter circuit 6 based on the difference between the actual output voltage and the desired voltage (which here is the reference voltage VREF).

The current mirror and steering circuit 9 and the error integrator circuit 10 work together to process this voltage difference. When the drive signal q(t) is high, switch S1 is closed, steering the current IREF to node N8. When q(t) is low, S2 closes, directing the current IREF to node N7. This alternating current flow charges and discharges capacitor CINT, creating a voltage VC at node N7 that represents the accumulated (integrated) voltage over time.

This time-varying voltage VC is of particular interest to implementing integral control because it accounts for persistent errors in the output voltage.

The low-pass filter circuit 11 smooths this signal, reducing high-frequency switching noise. The phase compensation circuit 12 then processes this smoothed signal. The RC network (C3 and R4) introduces a phase lead, which helps counteract phase delays in the converter circuit 6, improving the ability of the system to respond quickly to changes in load or input voltage.

Transconductors GM3 and GM4 convert the voltages at nodes N8, N9, and N6 into currents that modulate the frequencies of the feedback and reference current-controlled oscillators in the time-domain proportional-integral compensator circuit 8. The phase difference between these oscillator outputs represents the error in the output voltage, now encoded in the time domain.

This time-domain representation allows for potentially faster processing compared to voltage-domain methods, as time differences can be measured with high precision using digital logic. It also offers better noise immunity because time measurements are less susceptible to voltage noise than direct voltage measurements.

This design of the DC-DC converter 5′ provides for precise control over how the voltage error is translated into time-domain signals, allowing for fine tuning of how the converter responds to changes in load or input voltage. This enables sophisticated adjustment of the behavior of the control loop—how quickly and strongly the system reacts to errors—while maintaining the speed and potential noise immunity benefits of time-based control.

Finally, it is evident that modifications and variations can be made to what has been described and illustrated herein without departing from the scope of this disclosure.

Although this disclosure has been described with a limited number of embodiments, those skilled in the art, having the benefit of this disclosure, can envision other embodiments that do not deviate from the disclosed scope. Furthermore, skilled persons can envision embodiments that represent various combinations of the embodiments disclosed herein made in various ways.

1. A DC-DC converter, comprising:
a DC-DC converter circuit configured to generate an output voltage from an input voltage, and a feedback network coupled to receive the output voltage and configured to generate a feedback voltage; and
a control circuit including:
a high-pass filter coupled to receive the feedback voltage and configured to generate a filtered voltage;
a time-domain proportional-integral compensator circuit configured to: receive the feedback voltage and the filtered voltage, generate a first oscillating signal and a second oscillating signal based on the received feedback and filtered voltages, and generate a drive signal based on a comparison of the first and second oscillating signals; and
a driver circuit configured to control operation of the DC-DC converter circuit based on the drive signal.

2. The DC-DC converter of claim 1, wherein the time-domain proportional-integral compensator circuit comprises:
a first transconductor configured to convert the feedback voltage to a first current;
a second transconductor configured to convert the filtered voltage to a second current;
a feedback current-controlled oscillator (FCCO) configured to receive the first current and generate the first oscillating signal based thereupon;
a reference current-controlled oscillator (RCCO) configured to receive the second current and generate the second oscillating signal based thereupon; and
a phase detector configured to compare phases of the first and second oscillating signals and generate the drive signal based on the comparison.

3. The DC-DC converter of claim 2, wherein the first transconductor has a non-inverting input coupled to receive the feedback voltage and an inverting input coupled to a reference voltage node.

4. The DC-DC converter of claim 2, wherein the second transconductor has a non-inverting input coupled to receive the filtered voltage and an inverting input coupled to a reference voltage node.

5. The DC-DC converter of claim 2, wherein the phase detector is configured to generate the drive signal to control duty cycles of switching elements in the DC-DC converter circuit based on a phase difference between the first and second oscillating signals.

6. The DC-DC converter of claim 1, wherein the feedback network comprises:
a voltage divider coupled between an output node of the DC-DC converter circuit and a ground node.

7. The DC-DC converter of claim 1, wherein the high-pass filter comprises:
a capacitor coupled between a feedback node and a filter node; and
a resistor coupled between the filter node and a reference voltage node.

8. The DC-DC converter of claim 1, wherein the driver circuits are configured to control switching elements in the DC-DC converter circuit; further comprising an inverter coupled between the time-domain proportional-integral compensator circuit and one of the driver circuits.

9. The DC-DC converter of claim 1, wherein the time-domain proportional-integral compensator circuit is configured to implement a proportional-integral control function in the time domain without using delay lines.

10. The DC-DC converter of claim 1, further comprising:
a current steering circuit configured to alternately direct a reference current to a first node and a second node based on the drive signal;
an error integrator circuit configured to accumulate charge at the second node when the reference current is directed there, wherein the accumulated charge represents an integrated error based on a duty cycle of the drive signal;
a low-pass filter circuit configured to filter a voltage at the first node, wherein the voltage at the first node varies based on when the reference current is directed there; and
a phase compensation circuit configured to process the filtered voltage from the low-pass filter circuit and provide phase-advanced signals to the time-domain proportional-integral compensator circuit, wherein the phase-advanced signals are used to modulate the first and second oscillating signals in the time-domain proportional-integral compensator circuit.

11. The DC-DC converter of claim 10, wherein the current steering circuit comprises: a current mirror configured to generate the reference current; a first switch controlled by the drive signal and configured to selectively provide the reference current to the first node when the drive signal is in a first state; an inverter configured to invert the drive signal; and a second switch controlled by an output of the inverter and configured to selectively provide the reference current to the second node when the drive signal is in a second state opposite to the first state; wherein the first and second switches operate complementarily to alternately direct the reference current to the first node and the second node.

12. The DC-DC converter of claim 10, wherein the error integrator circuit comprises: an integration capacitor coupled between the second node and a ground node, configured to accumulate charge when the reference current is directed to the second node; and a transistor having a drain coupled to the second node, a source coupled to the ground node, and a gate coupled to receive a bias voltage.

13. The DC-DC converter of claim 10, wherein the low-pass filter circuit comprises: a filter capacitor coupled between the first node and a third node; and a filter resistor coupled between the first node and the third node.

14. The DC-DC converter of claim 10, wherein the phase compensation circuit comprises: a buffer coupled to the first node; a capacitor coupled between an output of the buffer and a fourth node; a resistor coupled between the fourth node and a third node; and a first additional transconductor and a second additional transconductor configured to convert voltage differences between the first node, the third node, and the fourth node into currents provided to the time-domain proportional-integral compensator circuit.

15. The DC-DC converter of claim 14,
wherein the time-domain proportional-integral compensator circuit comprises: a first transconductor configured to convert the feedback voltage to a first current; a second transconductor configured to convert the filtered voltage to a second current; a feedback current-controlled oscillator (FCCO) configured to receive the first current and generate the first oscillating signal based thereupon; a reference current-controlled oscillator (RCCO) configured to receive the second current and generate the second oscillating signal based thereupon; and a phase detector configured to compare phases of the first and second oscillating signals and generate the drive signal based on the comparison;
wherein the first additional transconductor has a non-inverting input coupled to the first node, an inverting input coupled to the third node, a non-inverting output coupled to provide current to the feedback current-controlled oscillator (FCCO), and an inverting output coupled to provide current to the reference current-controlled oscillator (RCCO); and
wherein the second additional transconductor has a non-inverting input coupled to the fourth node, an inverting input coupled to the third node, a non-inverting output coupled to provide current to the FCCO, and an inverting output coupled to provide current to the RCCO.

16. The DC-DC converter of claim 10, wherein the current steering circuit further comprises: an amplifier having a non-inverting input coupled to receive a reference voltage and an inverting input coupled to the second node; and a current mirror coupled to an output of the amplifier and configured to generate the reference current.

17. A method of operating a DC-DC converter, comprising:
generating an output voltage from an input voltage using a DC-DC converter circuit;
generating a feedback voltage based on the output voltage;
filtering the feedback voltage using a high-pass filter to generate a filtered voltage;
converting the feedback voltage to a first current and the filtered voltage to a second current;
generating a first oscillating signal based on the first current using a feedback current-controlled oscillator (FCCO);
generating a second oscillating signal based on the second current using a reference current-controlled oscillator (RCCO);
comparing phases of the first and second oscillating signals to generate a drive signal; and
controlling operation of the DC-DC converter circuit based on the drive signal.

18. The method of claim 17, further comprising:
alternately directing a reference current to a first node and a second node based on the drive signal;
accumulating charge at the second node when the reference current is directed there, wherein the accumulated charge represents an integrated error based on a duty cycle of the drive signal;
filtering a voltage at the first node using a low-pass filter, the voltage at the first node varies based on when the reference current is directed there;
processing the filtered voltage from the low-pass filter to provide phase-advanced signals; and
modulating the first and second oscillating signals based on the phase-advanced signals.

19. The method of claim 18, wherein alternately directing the reference current comprises:
generating the reference current using a current mirror; selectively providing the reference current to the first node when the drive signal is in a first state;
inverting the drive signal; and
selectively providing the reference current to the second node when the inverted drive signal is in a second state opposite to the first state.

20. The method of claim 18, wherein processing the filtered voltage to provide phase-advanced signals comprises:
buffering the voltage at the first node; applying a phase lead to the buffered voltage using an RC network;
converting voltage differences between the first node, a third node, and a fourth node into currents; and
providing the currents to the FCCO and RCCO to modulate the first and second oscillating signals.
